(19) United States
(12) Patent Application Publication
(10) Pub. No.: US 2012/0244765 A1
(43) Pub. Date: Sep. 27, 2012

(54) HYDROGEN POWER SUPPLY MODULE AND LIFE PRESERVER HAVING THE SAME

(76) Inventors: Shao-Chi HUANG, Hsinchu County (TW); Chieh-Ju Hung, Hsinchu County (TW); Cheng Wang, Hsinchu County (TW); Po-Kuei Chou, Hsinchu County (TW)

(21) Appl. No.: 13/396,964

(22) Filed: Feb. 15, 2012

(30) Foreign Application Priority Data
Mar. 25, 2011 (CN) 201110080157.6

(51) Int. Cl. B63C 9/20; H01M 8/10; F21L 4/00; B63C 9/11; A45C 15/00; H01M 8/06; H01M 8/02

(52) U.S. Cl. 441/89; 429/416; 429/421; 441/88; 224/576; 362/190

(57) ABSTRACT

A hydrogen power supply module includes a hydrogen production unit, a fuel cell unit, and a hydrogen flow channel. The hydrogen flow channel is in communication with the hydrogen production unit and the fuel cell unit, and a solid-state reactant is stored in the hydrogen production unit. A liquid-state reactant reacts with the solid-state reactant to produce hydrogen when the liquid-state reactant comes into contact with the solid-state reactant, and the hydrogen flows into the fuel cell unit via the hydrogen flow channel. A life preserver having the hydrogen power supply module is also provided.

### BACKGROUND OF THE INVENTION

a. Field of the Invention

The invention relates to a hydrogen power supply module and a life preserver.

b. Description of the Related Art

Due to global warming, climate system changes drastically and thus heavy rain, flood, or tsunami occurs frequently. Therefore, it is an important issue for rescue personnel to discover victims more easily and to use current life preservers more effectively in present climate crisis.

For example, Taiwan patent No. M349377 discloses a life buoy 100 having a warning light effect. As shown in FIG. 8. the life buoy 100 includes a light emitting belt 102, a strap 104 for fixing the light emitting belt 102, a power source 106, and a manual power supply device 108. The power source 106 and the manual power supply device 108 provide electric power for the light emitting belt 102 to allow the light emitting belt 102 to emit strong flashing light. Therefore, the life buoy 100 may cast brilliant warning light to increase the survival rate for emergency victims at sea. Besides, Taiwan patent publication No. 200925054 discloses a lifeboat equipped with a solar hydrogen production device. Specifically, hydrogen is produced by water electrolysis via solar energy and stored in an alloy bottle. The stored hydrogen is then transmitted to a fuel cell via hydrogen pipelines to activate the fuel cell and thus provide electric power for the lifeboat. Additionally, U.S. Pat. No. 5,326,297 discloses a life vest having a signaling device, and the signaling device is attached to a shoulder strap. For example, when a user falls into the sea, the signaling device automatically starts upon coming into contact with the sea water to transmit a distress signal to a receiver on a boat and to enable a loudspeaker to produce an audio signal.

However, the above designs fail to provide all advantages of operating convenience in an emergency situation, instant and miniature power supply, competent portability, and compliance with environmental standards.

### BRIEF SUMMARY OF THE INVENTION

The invention provides a hydrogen power supply module having at least one of the following advantages of convenient use, instant and miniature power supply, competent portability, easy production and compliance with environmental standards.

The invention also provides a life preserver having operating convenience in an emergency situation.

Other objects and advantages of the invention can be better understood from the technical characteristics disclosed by the invention.

In order to achieve one of the above purposes, all the purposes, or other purposes, one embodiment of the invention provides a hydrogen power supply module including a hydrogen production unit, a fuel cell unit, and a hydrogen flow channel. The hydrogen production unit stores a solid-state reactant. The fuel cell unit at least includes a membrane electrode assembly and an anode current-collector and a cathode current-collector separately disposed on two sides of the membrane electrode assembly. The hydrogen flow channel is in communication with the hydrogen production unit and the fuel cell unit. When a liquid-state reactant comes into contact with the solid-state reactant, the liquid-state reactant reacts with the solid-state reactant to produce hydrogen and the hydrogen flows into the fuel cell unit via the hydrogen flow channel.

In one embodiment, the hydrogen production unit includes a first zone for storing the solid-state reactant, a second zone for storing the liquid-state reactant, and a barrier layer for separating the first zone from the second zone. When an opening is formed on the barrier layer between the first zone and the second zone, the liquid-state reactant comes into contact with the solid-state reactant.

In one embodiment, the hydrogen production unit includes an inlet valve, and, when the inlet valve is opened, the liquid-state reactant comes into contact with the solid-state reactant. The inlet valve, for example, may be made of a water-soluble material or may be a pressure-sensitive valve opened via a pressure difference.

In one embodiment, the solid-state reactant includes at least one of Sodium Borohydride (NaBH₄), Potassium Borohydride (KBH₄), Magnesium Hydride (MgH₂), and Aluminum powder (Al), and the liquid-state reactant includes at least one of water, Cobalt Dichloride (CoCl₂) solution, and Nickel Dichloride (NiCl₂) solution.

According to another embodiment of the invention, a life preserver includes a portable carrier and a hydrogen power supply module. The hydrogen power supply module includes a hydrogen production unit, a fuel cell unit, and a hydrogen flow channel. The hydrogen production unit stores a solid-state reactant. The fuel cell unit at least includes a membrane electrode assembly and an anode current-collector and a cathode current-collector separately disposed on two sides of the membrane electrode assembly. The hydrogen flow channel is in communication with the hydrogen production unit and the fuel cell unit. When a liquid-state reactant comes into contact with the solid-state reactant, the liquid-state reactant reacts with the solid-state reactant to produce hydrogen, and the hydrogen flows into the fuel cell unit via the hydrogen flow channel to generate electric power. The electric power is used to generate a signal.

In one embodiment, the portable carrier is a life vest, and the hydrogen production unit may include a fluid bag disposed inside the life vest, a fuel chamber, and a separation membrane disposed between the fluid bag and the fuel chamber. Alternatively, the hydrogen production unit may include a fuel chamber having an inlet valve, and the inlet valve may include at least one check valve.

In one embodiment, the portable carrier is a life buoy, the life buoy contains oxygen gas, and a cathode of the fuel cell unit comes into contact with the oxygen gas.

In one embodiment, the life preserver further includes a signaling device for generating a very high frequency signal, a global positioning signal, a light signal, an electrical signal or an audio signal.

In one embodiment, the portable carrier may be a floating plate, a floating mark, a hand stick, a flash light, a backpack or a black box.

In conclusion, the embodiment or the embodiments of a hydrogen power supply module have at least one of the following advantages of simplified configuration, convenient use, competent portability, simple power management, easy production, and compliance with environmental standards. Besides, the hydrogen power supply module may be installed on a life preserver, and the life preserver may use the electric power generated by the hydrogen power supply module to generate at last one signal. When an accident occurs, the signal is provided for rescue personnel to thereby increase the survival rate for emergency victims.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a hydrogen power supply module according to an embodiment of the invention.

FIG. 2 shows a schematic diagram illustrating a hydrogen power supply module according to another embodiment of the invention.

FIG. 3 shows a schematic diagram illustrating a life vest having a hydrogen power supply module according to an embodiment of the invention.

FIG. 4A shows a cross-section cut along line A-A′ of FIG. 3 illustrating a hydrogen production unit according to an embodiment of the invention.

FIG. 4B shows a cross-section cut along line B-B′ of FIG. 3 illustrating a fuel cell unit according to an embodiment of the invention.

FIG. 5 shows a cross-section illustrating a hydrogen production unit according to another embodiment of the invention.

FIG. 6 shows a schematic diagram illustrating a life buoy having a hydrogen power supply module according to an embodiment of the invention.

FIG. 7A shows a cross-section cut along line C-C′ of FIG. 6 illustrating a hydrogen production unit according to an embodiment of the invention.

FIG. 7B shows a cross-section cut along line D-D′ of FIG. 6 illustrating a fuel cell unit according to an embodiment of the invention.

FIG. 8 shows a schematic diagram of a conventional life buoy having a warning light effect.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

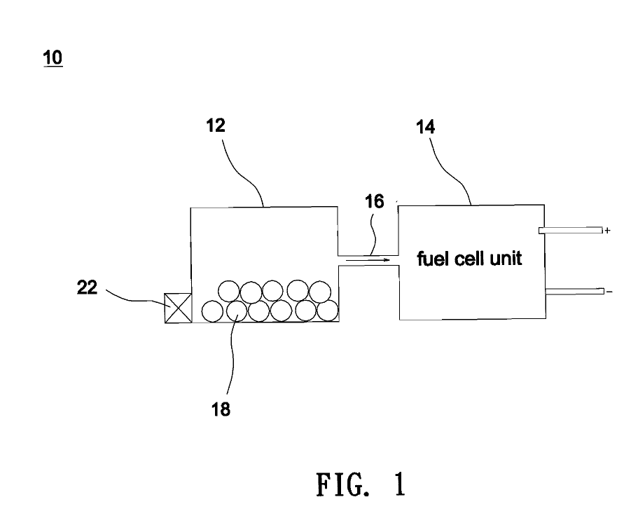

As shown in FIG. 1, a hydrogen power supply module 10 includes a hydrogen production unit 12, a fuel cell unit 14 and a hydrogen flow channel 16. A solid-state reactant 18 is stored in the hydrogen production unit 12, and the solid-state reactant 18 includes, but is not limited to, at least one of Sodium Borohydride, Potassium Borohydride, Magnesium hydride, and Aluminum powder. The hydrogen production unit 12 includes an inlet valve 22. When the inlet valve 22 is opened, a liquid-state reactant (not shown) from outside comes into contact with the solid-state reactant 18 and reacts with the solid-state reactant 18 to generate hydrogen. The hydrogen flows into the fuel cell unit 14 via the hydrogen flow channel 16 and serves as a fuel for the fuel cell unit 14 to generate electric power. In this embodiment, the method for opening the inlet valve 22 is not restricted. For example, a user may open the inlet valve 22 manually to allow outside water (such as river water, sea water, lake water, slurry, rain water, dew, saliva, urine, drink, etc.) to flow into the hydrogen production unit 12 and react with the solid-state reactant 18 to generate hydrogen. The hydrogen serves as a fuel for the fuel cell unit 14 to generate electric power. Alternatively, the inlet valve 22 may be a pressure-sensitive valve opened via a pressure difference. For example, in case the hydrogen power supply module 10 falls into water, the pressure sensitive valve is opened due to water pressure. In that case, water flows into the hydrogen production unit 12 and reacts with the solid-state reactant 18 to generate hydrogen. In an alternate embodiment, the inlet valve 22 is made of a water-soluble material such as polyvinyl alcohol. In case the hydrogen power supply module 10 falls into water, the water-soluble material dissolves in water to form an opening on the inlet valve 22, and thus outside water is allowed to flow into the hydrogen production unit 12.

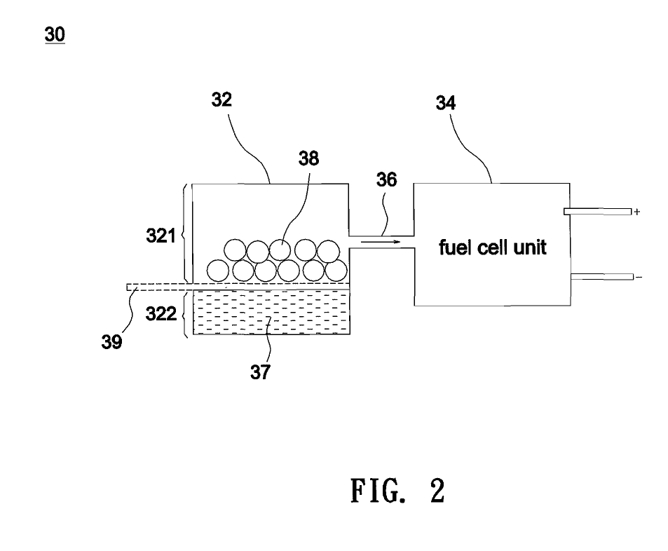

Referring to FIG. 2, a hydrogen power supply module 30 includes a hydrogen production unit 32, a fuel cell unit 34, and a hydrogen flow channel 36. The hydrogen production unit 32 includes a first zone 321 for storing a solid-state reactant 38, a second zone 322 for storing a liquid-state reactant 37, and a barrier layer 39 for separating the first zone 321 from the second zone 322. The barrier layer 39 may a separation membrane. The solid-state reactant 38 includes, for example, Sodium Borohydride, Potassium Borohydride, Magnesium Hydride, Aluminum powder, etc. The liquid-state reactant 37 includes, for example, water, Cobalt Dichloride solution, Nickel Dichloride solution, etc. When a user removes the barrier layer 39 or forms an opening on the barrier layer 39 between the first zone 321 and the second zone 322, the liquid-state reactant 37 comes into contact and reacts with the solid-state reactant 38 to generate hydrogen. The hydrogen flows into the fuel cell unit 34 via the hydrogen flow channel 36 and serves as a fuel for the fuel cell unit 34 to generate electric power.

For example, the hydrogen power supply module may be disposed in an object, such as clothing, a toy, a fluorescence stick, a clown suit, a hat, and a magic stage prop, to provide portable and instant electric power and achieve environmental protection. When a user removes the barrier layer 39, the electric power generated by the fuel cell unit 34 may be used to produce various styling and acoustic-optic effects. Alternatively, the hydrogen power supply module may be formed as a sticker to be attached to a human body, a transportation vehicle, or a daily-use article such as a backpack to provide a miniature electric power source that is convenience in use. Besides, if the hydrogen power supply module is applied in rescue applications, the hydrogen power supply module may further provide operating convenience in an emergency situation. Therefore, various embodiments of life preservers having the above hydrogen power supply module are described in the following.

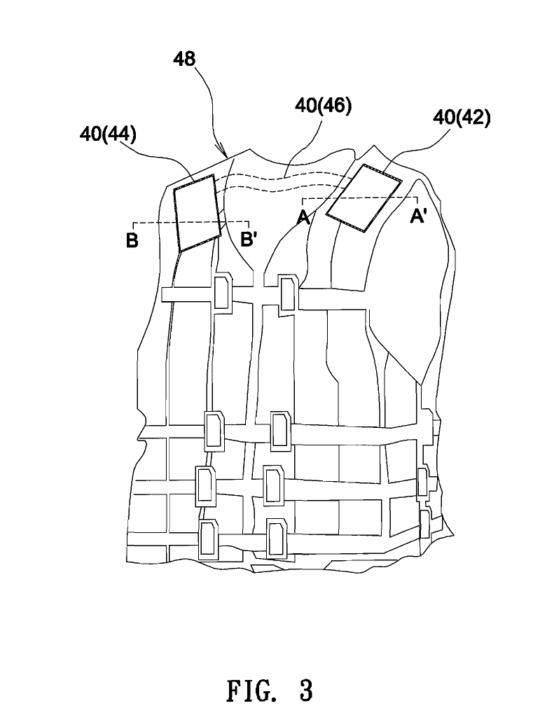

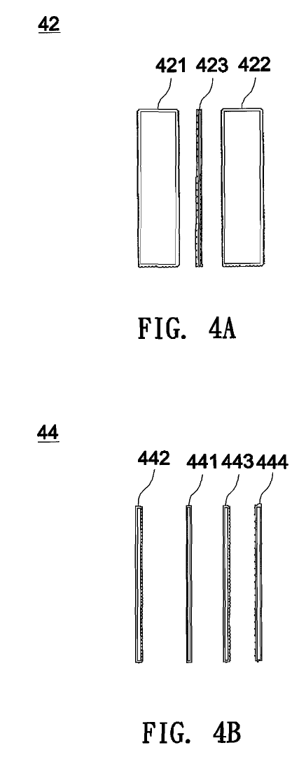

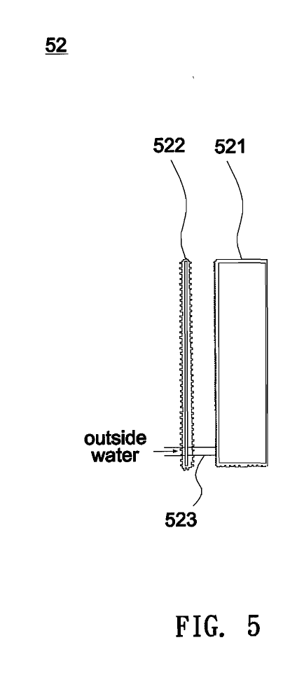

As shown in FIG. 3, in one embodiment, a life vest 48 is used as a portable carrier for a hydrogen power supply module 40. The hydrogen power supply module 40 is installed on the life vest 48 by various methods. For example, the hydrogen power supply module 40 is disposed inside the life vest 48 or connected with the life vest 48 by adhering, tying or riveting. The hydrogen power supply module 40 includes a hydrogen production unit 42 and a fuel cell unit 44. The hydrogen generated by the hydrogen production unit 42 flows into the fuel cell unit 44 via a hydrogen flow channel 46. As shown in FIG. 4A, the hydrogen production unit 42 includes, for example, a fluid bag 421, a fuel chamber 422, and a separation membrane 423 disposed between the fluid bag 421 and the fuel chamber 422. The fluid bag 421 stores a liquid-state reactant, and the fuel chamber 422 stores a solid-state reactant. A user may extract or break the separation membrane 423 to allow the liquid-state reactant to flow into the fuel chamber 422 to generate hydrogen. The hydrogen flows into the fuel cell unit 44 via the hydrogen flow channel 46 and serves as a fuel for the fuel cell unit 44. As shown in FIG. 4B, the fuel cell unit 44 may include, for example, a membrane electrode assembly (MEA) 441, an anode current-collector 442, a cathode current-collector 443, and a water-repellent permeable membrane 444. The anode current-collector 442 and the cathode current-collector 443 are separately disposed on two sides of the membrane electrode assembly 441, and the membrane electrode assembly 441 includes components such as proton exchange membrane, catalytic layer and gas diffusing layer. The water-repellent permeable membrane 444 may cover the membrane electrode assembly 441, the anode current-collector 442, and the cathode current-collector 443. The hydrogen generated by the hydrogen production unit 42 serves as a fuel for the fuel cell unit 44 to generate electric power. The electric power generated by the fuel cell unit 44 may be used to generate a signal like a light signal, an electrical signal, a radio-frequency signal, an audio signal, etc. The light signal, electrical signal or audio signal may draw attention of rescue personnel, or the radio frequency signal is directly transmitted to rescue personnel to increase the survival rate for emergency victims. For example, the fuel cell unit 44 is electrically connected to a signaling device (not shown) such as a light-emitting diode module, a very high frequency (VHF) generator, a global positioning device, etc. The signaling device uses the electric power generated by the hydrogen power supply module 40 to generate a signal. Specifically, when the signaling device is a light-emitting diode module, emission of light (light signal) may draw attention of rescue personnel. Further, in case the signaling device is a very high frequency generator or a global positioning device, a VHF signal or a GPS signal is directly transmitted to rescue personnel to enable rescue personnel to easily identify the position of victims. As shown in FIG. 5, in an alternate embodiment, a hydrogen production unit 52 includes a fuel chamber 521, a water-proof membrane 522 covering the fuel chamber 521, and an inlet valve 523 in communication with the fuel chamber 521. For example, the inlet valve 523 is a pressure sensitive valve. When a victim falls into water, the pressure sensitive valve is opened due to a pressure difference, and the water outside the fuel chamber 521 (such as sea water) flows into the fuel chamber 521 and reacts to generate hydrogen. Alternatively, the inlet valve 523 may be made of a water-soluble material such as polyvinyl alcohol. When a victim falls into water, the water outside the fuel chamber 521 forms an opening on the inlet valve 523 and flows into the fuel chamber 521. In one embodiment, the inlet valve 523 may include at least one check valve, and, by means of the check valve, the water outside the fuel chamber 521 ceases flowing into the inlet valve 523 upon reaching a predetermined amount.

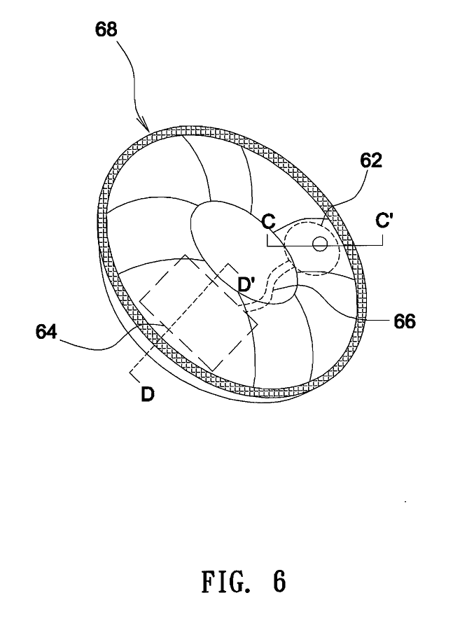

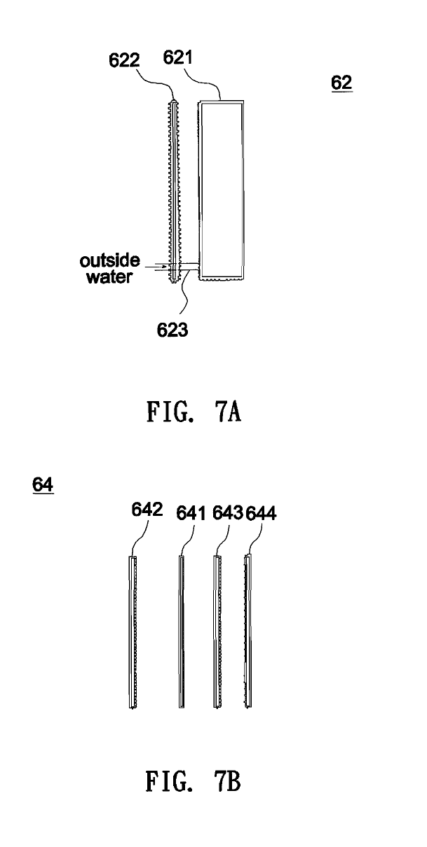

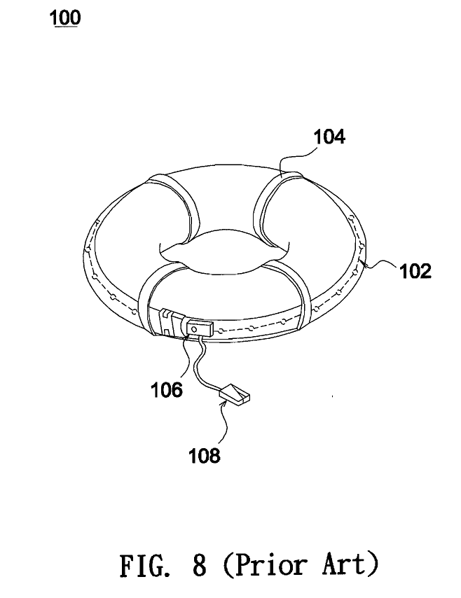

Please refer to FIGS. 6, 7A, and 7B, in one embodiment, a life buoy 68 is used as a portable carrier for a hydrogen power supply module. In this embodiment, a hydrogen production unit 62 and a fuel cell unit 64 are disposed inside the life buoy 68. The hydrogen production unit 62 and the fuel cell unit 64 are in communication with each other via a hydrogen flow channel 66. The position of the hydrogen production unit 62 and the fuel cell unit 64 inside the life buoy 68 is not restricted. Air or high-concentration oxygen is filled into the life buoy 68. The fuel cell unit 64 includes, for example, a membrane electrode assembly 641, an anode current-collector 642, a cathode current-collector 643, and a water-repellent permeable membrane 644. A cathode of the membrane electrode assembly 641 comes into contact with the oxygen inside the life buoy 68, and the hydrogen flows into an anode of the membrane electrode assembly 641 via the hydrogen flow channel 66. The hydrogen production unit 62 includes a fuel chamber 621, a water-proof membrane 622 covering the fuel chamber 621, and an inlet valve 623 in communication with the fuel chamber 621. For example, when the life buoy 68 falls into sea, sea water flows into the fuel chamber 621 via the inlet valve 623 to generate hydrogen that serves as a fuel for the fuel cell unit 64. The electric power generated by the fuel cell unit 64 may generate a signal like a light signal, an electrical signal, a radio-frequency signal, an audio signal, etc. In this embodiment, since the anode and the cathode of the fuel cell unit 64 are both positioned inside the life buoy 68, the fuel cell unit 64 does not break down even the fuel cell unit 64 is submerged by sea water.

In practical application, the life preserver according to the invention is not limited to the above mentioned life vest and life buoy, and may be a floating plate, a floating mark, a hand stick, a flash light, a backpack, a black box, etc.

In conclusion, the embodiment or the embodiments of a hydrogen power supply module have at least one of the following advantages of simplified configuration, convenient use, competent portability, simple power management, easy production, and compliance with environmental standards due to the use of a hydrogen fuel cell. Besides, the hydrogen power supply module may be installed on a life preserver, and the life preserver may use the electric power generated by the hydrogen power supply module to generate a signal. When an accident occurs, the signal is provided for rescue personnel to increase the survival rate for emergency victims.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A hydrogen power supply module, comprising:
a hydrogen production unit for storing a solid-state reactant;
a fuel cell unit at least comprising a membrane electrode assembly and an anode current-collector and a cathode current-collector separately disposed on two sides of the membrane electrode assembly; and
a hydrogen flow channel in communication with the hydrogen production unit and the fuel cell unit, wherein a liquid-state reactant reacts with the solid-state reactant to produce hydrogen when the liquid-state reactant comes into contact with the solid-state reactant, and the hydrogen flows into the fuel cell unit via the hydrogen flow channel.

2. The hydrogen power supply module as claimed in claim 1, wherein the hydrogen production unit comprises:
a first zone for storing the solid-state reactant;
a second zone for storing the liquid-state reactant; and
a barrier layer for separating the first zone from the second zone, wherein the liquid-state reactant comes into contact with the solid-state reactant when an opening is formed on the barrier layer between the first zone and the second zone.

3. The hydrogen power supply module as claimed in claim 1, wherein the hydrogen production unit comprises an inlet valve and, when the inlet valve is opened, the liquid-state reactant comes into contact with the solid-state reactant.

4. The hydrogen power supply module as claimed in claim 3, wherein the inlet valve is made of a water-soluble material.

5. The hydrogen power supply module as claimed in claim 4, wherein the water-soluble material comprises polyvinyl alcohol.

6. The hydrogen power supply module as claimed in claim 3, wherein the inlet valve is a pressure sensitive valve opened via a pressure difference.

7. The hydrogen power supply module as claimed in claim 1, wherein the fuel cell unit further comprises a water-repellent permeable membrane to cover the membrane electrode assembly, the anode current-collector and the cathode current-collector.

8. The hydrogen power supply module as claimed in claim 1, wherein the solid-state reactant comprises at least one of Sodium Borohydride, Potassium Borohydride, Magnesium Hydride and Aluminum powder, and the liquid-state reactant comprises at least one of water, Cobalt Dichloride solution and Nickel Dichloride solution.

9. A life preserver, comprising:
a portable carrier; and
a hydrogen power supply module connected with the portable carrier, wherein the hydrogen power supply module comprises:
a hydrogen production unit for storing a solid-state reactant;
a fuel cell unit at least comprising a membrane electrode assembly and an anode current-collector and a cathode current-collector separately disposed on two sides of the membrane electrode assembly; and
a hydrogen flow channel in communication with the hydrogen production unit and the fuel cell unit, wherein a liquid-state reactant reacts with the solid-state reactant to produce hydrogen when the liquid-state reactant comes into contact with the solid-state reactant, and the hydrogen flows into the fuel cell unit via the hydrogen flow channel to generate electric power.

10. The life preserver as claimed in claim 9, wherein the portable carrier is a life vest.

11. The life preserver as claimed in claim 10, wherein the hydrogen production unit is disposed inside the life vest, the hydrogen production unit comprises a fluid bag, a fuel chamber, and a separation membrane disposed between the fluid bag and the fuel chamber, the liquid-state reactant is stored in the fluid bag, and the solid-state reactant is stored in the fuel chamber.

12. The life preserver as claimed in claim 10, wherein the hydrogen production unit comprises a fuel chamber having an inlet valve and the solid-state reactant is stored in the fuel chamber.

13. The life preserver as claimed in claim 12, wherein the inlet valve is made of a water-soluble material.

14. The life preserver as claimed in claim 12, wherein the inlet valve is a pressure sensitive valve opened via a pressure difference.

15. The life preserver as claimed in claim 12, wherein the inlet valve comprises at least one check valve.

16. The life preserver as claimed in claim 9, wherein the portable carrier is a life buoy.

17. The life preserver as claimed in claim 16, wherein the life buoy contains oxygen gas and a cathode of the fuel cell unit comes into contact with the oxygen gas.

18. The life preserver as claimed in claim 9, further comprising:
a signaling device electrically connected with the hydrogen power supply module and receiving the electric power to transmit a signal.

19. The life preserver as claimed in claim 18, wherein the signal comprises at least one of a very high frequency (VHF) signal, a global positioning signal, a light signal, an electrical signal, and an audio signal.

20. The life preserver as claimed in claim 9, wherein the portable carrier comprises at least one of a floating plate, a floating mark, a hand stick, a flash light, a backpack, and a black box.
